(19) United States
(12) Patent Application Publication
(10) Pub. No.: US 2022/0097586 A1
(43) Pub. Date: Mar. 31, 2022

(54) Portable Mug Holder Assembly

(71) Applicant: James Smith, Crest Hill, IL (US)

(72) Inventor: James Smith, Crest Hill, IL (US)

(21) Appl. No.: 17/032,051

(22) Filed: Sep. 25, 2020

(51) Int. Cl. B60N 3/10; A47G 19/22; A47G 1/06; B65D 25/20; B65D 25/28

(52) U.S. Cl. CPC B60N 3/103; A47G 19/2227; B65D 25/2811; B65D 25/20; B65D 25/205; A47G 1/06

(57) ABSTRACT

A portable mug holder assembly for facilitating a cup holder in any vehicle includes a first strip that is foldable to define a central portion extending between a pair of outward portions such that the first strip forms a U shape. A second strip is removably attachable to the first strip when the first strip is folded to form a cup holder that can be positioned in a vehicle. A cup is positionable in the cup holder to store the cup in an upright position in the vehicle. The cup has a photo space integrated therein for having a photo inserted therein. A base is removably attachable to the cup to retain the photo in the photo space.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to holder devices and more particularly pertains to a new holder device for facilitating a cup holder in any vehicle.

### (2) Description of Related Art Including Information Disclosed Under 37 CFR 1.97 and 1.98

The prior art relates to holder devices including a foldable panel that is foldable into a cup holder. The prior art discloses a collapsible cone for forming a bottle holder. The prior art discloses a beverage cup that has a removable base. The prior art discloses a variety of foldable panels that have a plurality of cutouts for forming a cup holder when folded.

### BRIEF SUMMARY OF THE INVENTION

An embodiment of the disclosure meets the needs presented above by generally comprising a first strip that is foldable to define a central portion extending between a pair of outward portions such that the first strip forms a U shape. A second strip is removably attachable to the first strip when the first strip is folded to form a cup holder that can be positioned in a vehicle. A cup is positionable in the cup holder to store the cup in an upright position in the vehicle. The cup has a photo space integrated therein for having a photo inserted therein. A base is removably attachable to the cup to retain the photo in the photo space.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a portable mug holder assembly according to an embodiment of the disclosure.

FIG. 2 is a top perspective view of an embodiment of the disclosure.

FIG. 3 is a right side view of an embodiment of the disclosure.

FIG. 4 is a front view of an embodiment of the disclosure.

FIG. 5 is a top view of an embodiment of the disclosure.

FIG. 6 is a perspective in-use view of an embodiment of the disclosure.

FIG. 7 is an exploded perspective view of an embodiment of the disclosure.

### DETAILED DESCRIPTION OF THE INVENTION

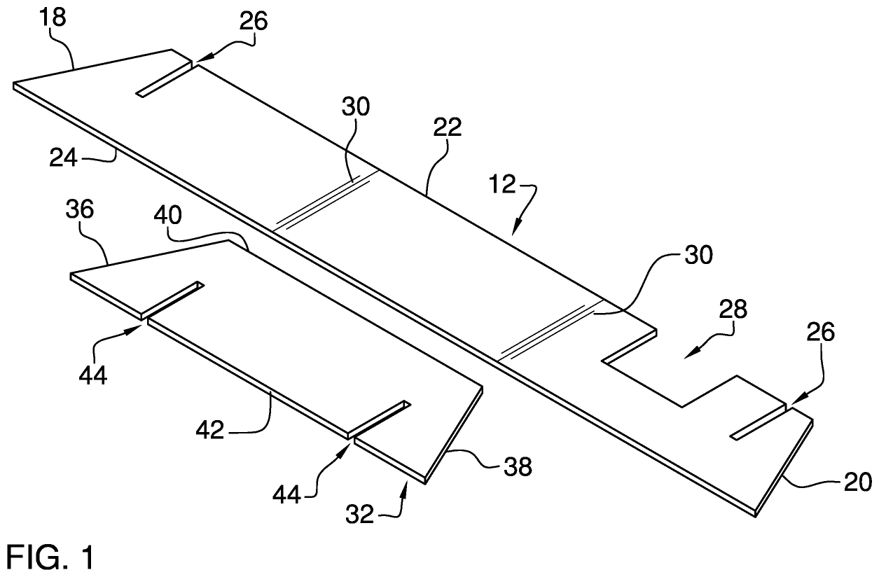

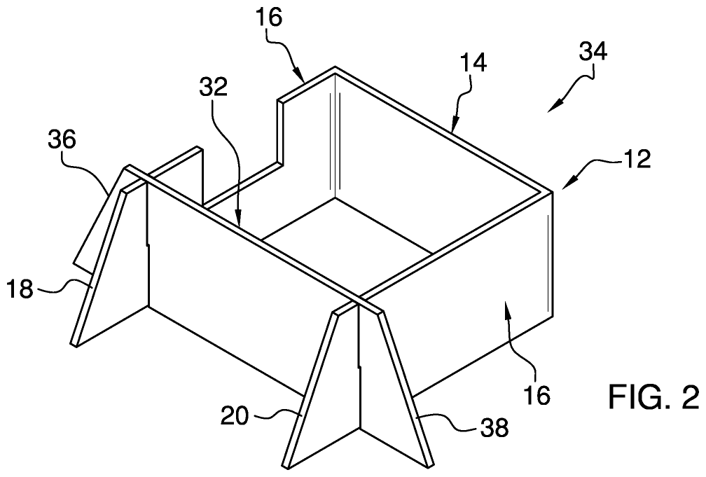

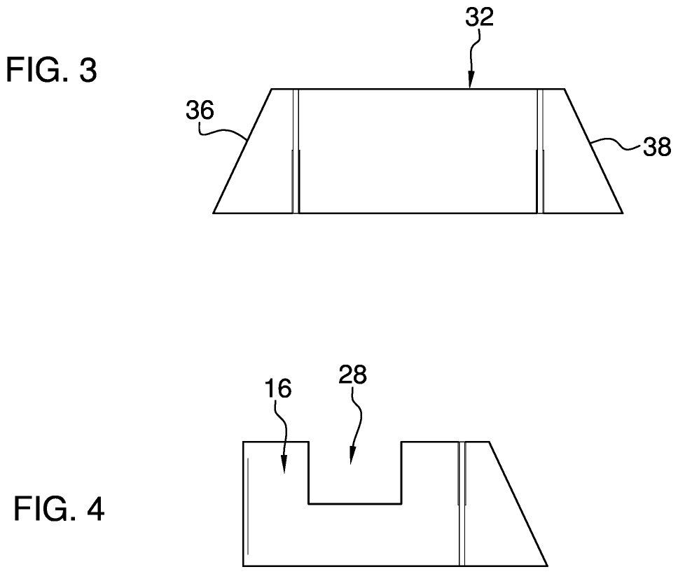

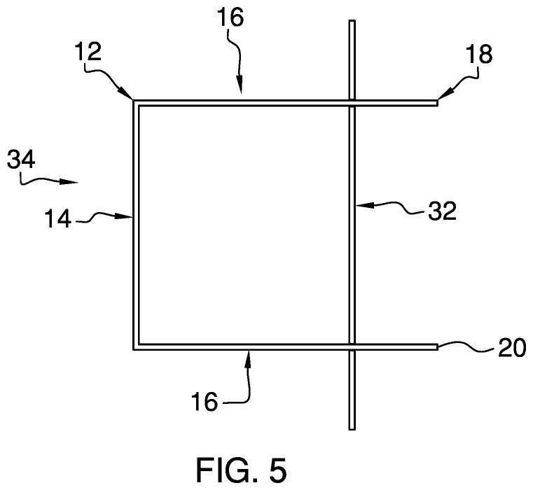

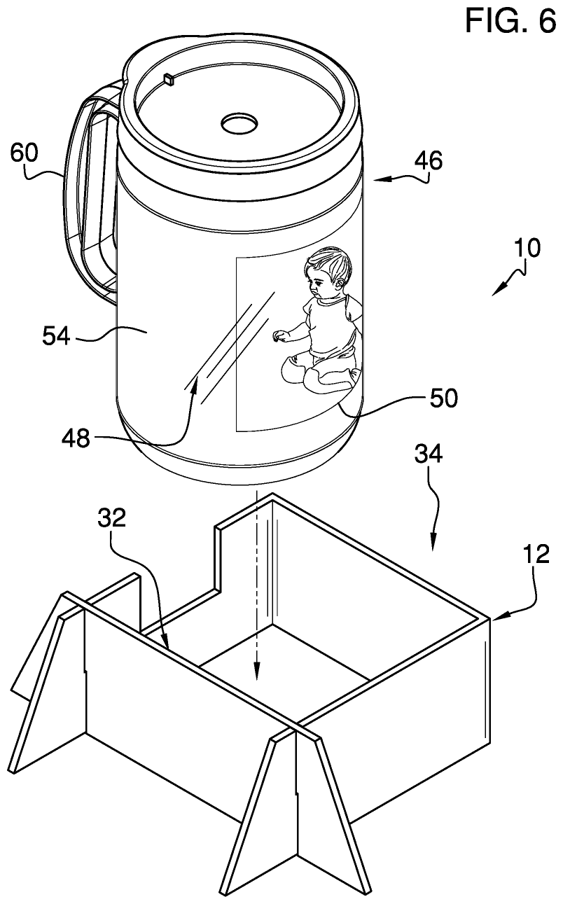

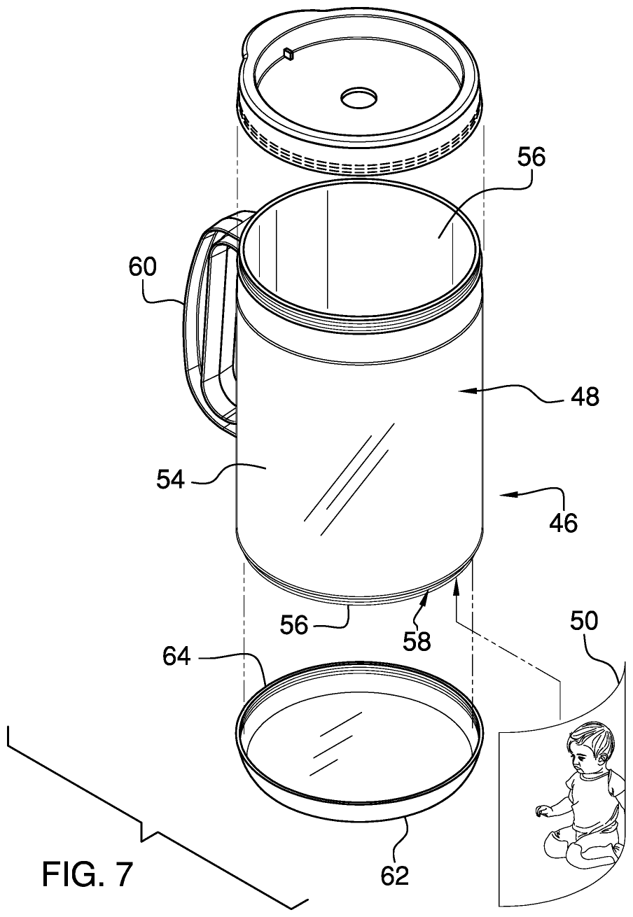

With reference now to the drawings, and in particular to FIGS. 1 through 7 thereof, a new holder device embodying the principles and concepts of an embodiment of the disclosure and generally designated by the reference numeral 10 will be described.

As best illustrated in FIGS. 1 through 7, the portable mug holder assembly 10 generally comprises a first strip 12 that is foldable to define a central portion 14 extending between a pair of outward portions 16 such that the first strip 12 forms a U shape. The first strip 12 has a first end 18, a second end 20, a top edge 22 and a bottom edge 24, and the first strip 12 is elongated between the first end 18 and the second end 20. Each of the first end 18 and the second end 20 slope toward a center of the first strip 12 between the bottom edge 24 and the top edge 22. The first strip 12 may have a length ranging between approximately 10.0 inches and 20.0 inches.

The first strip 12 has a pair of first slots 26 each being integrated therein and each of the first slots 26 extends from the top edge 22 toward the bottom edge 24. Each of the first slots 26 is positioned adjacent to a respective one of the first end 18 and the second end 20. Additionally, the first strip 12 has a handle space 28 being integrated therein and the handle space 28 extends from the top edge 22 toward the bottom edge 24. The handle space 28 is elongated between the first end 18 and the second end 20, and the handle space 28 is positioned adjacent to a respective one of the first slots 26. The first strip 12 has a pair of fold lines 30 each extending between the top edge 22 and the bottom edge 24. Each of the fold lines 30 is spaced in opposite directions from the center of the first strip 12 and each of the first slots 26 is aligned with each other when the first strip 12 is folded along each of the fold lines 30.

A second strip 32 is removably attachable to the first strip 12 when the first strip 12 is folded. In this way the first strip 12 and the second strip 32 form a cup holder 34 that can be positioned in a vehicle. The vehicle may be a passenger vehicle such as a car, a cargo vehicle such as a semi tractor or any other motorized vehicle that is driven on public roadways. The second strip 32 has a primary end 36, a secondary end 38, an upper edge 40 and a lower edge 42. Each of the primary end 36 and the secondary end 38 slopes toward a center of the second strip 32 between the lower edge 42 and the upper edge 40.

The second strip 32 has a pair of second slots 44 each being integrated therein and each of the second slots 44 engages a respective one of the first slots 26 for releasably retaining the second strip 32 on the first strip 12. Each of the second slots 44 extends from the lower edge 42 toward the upper edge 40 and each of the second slots 44 is positioned adjacent to a respective one of the primary end 36 and the secondary end 38. The second strip 32 extends between each of the outward portions 16 of the first strip 12 when the second strip 32 is removably attached to the first strip 12.

A cup 46 is provided that can contain a beverage and the cup 46 is positionable in the cup holder 34 for storing in an upright position in the vehicle. In this way the cup 46 can be stored in a vehicle that does not have factory cup holders or that does not have cup holders large enough to accommodate the cup 46. The cup 46 may have a fluid capacity of at least 64.0 ounces thereby potentially requiring an oversized cup holder compared to the factory cup holders in the vehicle.

The cup 46 has a photo space 48 integrated therein for insertably receiving a photo 50. The cup 46 has an inner wall 52 and an outer wall 54, and the inner wall 52 is spaced from the outer wall 54 to define the photo space 48 between the inner wall 52 and the outer wall 54. The cup 46 has a lower end 56 and the outer wall 54 is spaced from the lower end 56 to define an entry 58 into the photo space 48. The entry 58 extends around a full circumference of the cup 46 and the inner wall 52 is threaded adjacent to the lower end 56. Moreover, the outer wall 54 is comprised of a translucent material to facilitate the photo 50 to be visible through the outer wall 54.

A handle 60 is coupled to the outer wall 54 of the handle 60 and the handle space 28 in the first strap accommodates the handle 60 when the cup 46 is positioned in the cup holder 34. A base 62 is removably attachable to the cup 46 to retain the photo 50 in the photo space 48. The base 62 has an outer edge 64 and the base 62 is threaded adjacent to the outer edge 64 for threadably engaging the inner wall 52 of the cup 46. In this way the base 62 is attached to the cup 46 having the base 62 resting against the lower end 56 of the cup 46.

In use, the first strip 12 is folded along each of the fold lines 30 and the second strip 32 is attached to the second strip 32. In this way the first strip 12 and the second strip 32 form a cup holder 34 that can be positioned in any vehicle. The cup 46 is positioned in the cup holder 34 when the cup 46 is not in use. In this way the oversized cup 46 can be held in any vehicle regardless of the size of the factory cup holders in the vehicle.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A portable mug holder assembly for facilitating a mug holder to be placed in a vehicle, said assembly comprising:
a first strip being foldable to define a central portion extending between a pair of outward portions such that said first strip forms a U shape, said first strip having a pair of first slots each being integrated therein;
a second strip being removably attachable to said first strip when said first strip is folded having said first strip and said second strip forming an cup holder wherein said cup holder is configured to be positioned in a vehicle, said second strip having a pair of second slots each being integrated therein, each of said second slots engaging a respective one of said first slots for releasably retaining said second strip on said first strip;
a cup being configured to contain a beverage, said cup being positionable in said cup holder wherein said cup is configured to be stored in a upright position in the vehicle, said cup having a photo space being integrated therein wherein said photo space is configured to have a photo inserted therein; and
a base being removably attachable to said cup wherein said base is configured to retain the photo in said photo space.

2. The assembly according to claim 1, wherein said first strip has a first end, a second end, a top edge and a bottom edge, said first strip being elongated between said first end and said second end, each of said first end and said second end sloping toward a center of said first strip between said bottom edge and said top edge.

3. The assembly according to claim 2, wherein each of said first slots extends from said top edge toward said bottom edge, each of said first slots being positioned adjacent to a respective one of said first end and said second end.

4. The assembly according to claim 3, wherein said first strip has a handle space being integrated therein, said handle space extending from said top edge toward said bottom edge, said handle space being elongated between said first end and said second end, said handle space being positioned adjacent to a respective one of said first slots.

5. The assembly according to claim 2, wherein said first strip has a pair of fold lines each extending between said top edge and said bottom edge, each of said fold lines being spaced in opposite directions from said center of said first strip, each of said first slots being aligned with each other when said first strip is folded along each of said fold lines.

6. The assembly according to claim 1, wherein said second strip has a primary end, a secondary end, an upper edge and a lower edge, each of said primary end and said secondary end sloping toward a center of said second strip between said lower edge and said upper edge.

7. The assembly according to claim 6, wherein each of said second slots extends from said lower edge toward said upper edge, each of said second slots being positioned adjacent to a respective one of said primary end and said secondary end.

8. The assembly according to claim 1, wherein said cup has an inner wall and an outer wall, said inner wall being spaced from said outer wall to define said photo space between said inner wall and said outer wall, said cup having a lower end, said outer wall being spaced from said lower end to define an entry into said photo space extending around a full circumference of said cup.

9. The assembly according to claim 8, wherein said inner wall is threaded adjacent to said lower end.

10. The assembly according to claim 8, wherein said outer wall is comprised of a translucent material wherein said outer wall is configured to facilitate the photo to be visible through said outer wall.

11. The assembly according to claim 8, wherein:
said first handle has a handle space being integrated therein; and
said outer wall has a handle being coupled thereto, said handle space in said first strap accommodating said handle when said cup is positioned in said cup holder.

12. The assembly according to claim 8, wherein said base has an outer edge, said base being threaded adjacent to said outer edge for threadably engaging said inner wall of said cup having said base resting against said lower end of said cup.

13. A portable mug holder assembly for facilitating a mug holder to be placed in a vehicle, said assembly comprising:
a first strip being foldable to define a central portion extending between a pair of outward portions such that said first strip forms a U shape, said first strip having a first end, a second end, a top edge and a bottom edge, said first strip being elongated between said first end and said second end, each of said first end and said second end sloping toward a center of said first strip between said bottom edge and said top edge, said first strip having a pair of first slots each being integrated therein, each of said first slots extending from said top edge toward said bottom edge, each of said first slots being positioned adjacent to a respective one of said first end and said second end, said first strip having a handle space being integrated therein, said handle space extending from said top edge toward said bottom edge, said handle space being elongated between said first end and said second end, said handle space being positioned adjacent to a respective one of said first slots, said first strip having a pair of fold lines each extending between said top edge and said bottom edge, each of said fold lines being spaced in opposite directions from said center of said first strip, each of said first slots being aligned with each other when said first strip is folded along each of said fold lines;
a second strip being removably attachable to said first strip when said first strip is folded having said first strip and said second strip forming an cup holder wherein said cup holder is configured to be positioned in a vehicle, said second strip having a primary end, a secondary end, an upper edge and a lower edge, each of said primary end and said secondary end sloping toward a center of said second strip between said lower edge and said upper edge, said second strip having a pair of second slots each being integrated therein, each of said second slots engaging a respective one of said first slots for releasably retaining said second strip on said first strip, each of said second slots extending from said lower edge toward said upper edge, each of said second slots being positioned adjacent to a respective one of said primary end and said secondary end, said second strip extending between each of said outward portions of said first strip when said second strip is removably attached to said first strip;
a cup being configured to contain a beverage, said cup being positionable in said cup holder wherein said cup is configured to be stored in a upright position in the vehicle, said cup having a photo space being integrated therein wherein said photo space is configured to have a photo inserted therein, said cup having an inner wall and an outer wall, said inner wall being spaced from said outer wall to define said photo space between said inner wall and said outer wall, said cup having a lower end, said outer wall being spaced from said lower end to define an entry into said photo space extending around a full circumference of said cup, said inner wall being threaded adjacent to said lower end, said outer wall being comprised of a translucent material wherein said outer wall is configured to facilitate the photo to be visible through said outer wall, said outer wall having a handle being coupled thereto, said handle space in said first strap accommodating said handle when said cup is positioned in said cup holder; and
a base being removably attachable to said cup wherein said base is configured to retain the photo in said photo space, said base having an outer edge, said base being threaded adjacent to said outer edge for threadably engaging said inner wall of said cup having said base resting against said lower end of said cup.
